(19) United States
(12) Patent Application Publication
(10) Pub. No.: US 2026/0273779 A1
(43) Pub. Date: Sep. 17, 2026

(54) Link for Industrial Robot, and Industrial Robot

(71) Applicant: ABB Schweiz AG, Baden (CH)

(72) Inventors: Simon Hallstadius Linge, Västerås (SE); Tomas Botold, Västerås (SE); Jiangwei Huang, Västerås (SE)

(21) Appl. No.: 19/674,572

(22) Filed: May 12, 2026

Related U.S. Application Data
(63) Continuation of application No. PCT/EP2023/082087, filed on Nov. 16, 2023.

(51) Int. Cl. B25J 18/00; B25J 19/00

(52) U.S. Cl. CPC B25J 18/00; B25J 19/0075

(57) ABSTRACT

A link for an industrial robot, the link including a main body for interconnecting a first joint and a second joint of the industrial robot, the main body including an exterior continuous main surface including a planar first surface section and a planar second surface section; a first opening in the first surface section; a second opening in the second surface section; a first cover sealingly closing the first opening and including an exterior planar first cover surface substantially flush with the first surface section; and a second cover sealingly closing the second opening and including an exterior planar second cover surface substantially flush with the second surface section. An industrial robot including a link is also provided.

### TECHNICAL FIELD

The present disclosure generally relates to industrial robots. In particular, a link for an industrial robot, and an industrial robot comprising a link, are provided.

### BACKGROUND

In some processing environments, it is desirable to maintain a high level of hygiene. Examples of such processing environments include environments where food, beverages or pharmaceuticals are handled by an industrial robot. Any sanitary problem in such processing environment might result in severe consequences. For this reason, comprehensive cleaning of the robot and its surroundings is often performed on a daily basis. A typical cleaning procedure includes high pressure washing with hot water containing a cleaning agent, application of a detergent for some time, such as 15 minutes, and washing off the detergent.

US 2019193262 A1 discloses an articulated arm apparatus comprising a first arm segment, an elbow joint, a second arm segment, an end joint, a shoulder cap, an elbow cap and an end cap. The apparatus is said to be leak tight as regards air, process fluids and cleaning fluids.

Although the articulated arm apparatus in US 2019193262 A1 is described as being compatible with various decontamination methods, meeting a particle generation requirement, and able to be used in sterile systems, the apparatus comprises several protruding and recessed geometric features, such as bosses and debosses. These geometric features collect contaminants and are difficult to clean, which jeopardizes the hygienic properties of the design. Such geometric features may require cleaning from multiple angles, and even such cleaning may not be effective enough.

### SUMMARY

One object of the invention is to provide an improved link for an industrial robot.

A further object of the invention is to provide an improved industrial robot comprising a link.

These objects are achieved by the link and by the industrial robot according to the claims.

The invention is based on the realization that by providing a link for an industrial robot comprising an exterior continuous main surface flush with each of a cover surface of two different covers of the link, an improved hygienic design of the link is obtained.

According to a first aspect, there is provided a link for an industrial robot, the link comprising a main body for interconnecting a first joint and a second joint of the industrial robot, the main body comprising an exterior continuous main surface including a planar first surface section and a planar second surface section; a first opening in the first surface section; a second opening in the second surface section; a first cover sealingly closing the first opening and including an exterior planar first cover surface substantially flush with, or flush with, the first surface section; and a second cover sealingly closing the second opening and including an exterior planar second cover surface substantially flush with, or flush with, the second surface section.

Since the main surface is continuous, the main surface does not comprise any edges, bosses, debosses or pockets where contaminants can be collected. Due to the main surface being continuous and including the first and second surface sections, which in turn are substantially flush with the first and second cover surfaces, respectively, irregularities on the link are reduced or eliminated. The design of the link therefore reduces a risk of accumulation of contaminants, such as bacterial residue. Moreover, the design of the link enables a more effective and efficient cleaning of the link. For example, the reduction or elimination of irregularities enables a better, i.e., more effective, cleaning of the link, and the design of the link enables the main surface and the first and second cover surfaces to be cleaned in common in a common cleaning operation, such as by spraying a cleaning liquid at a defined angle onto the main surface. The cleaning can therefore be performed easier, in a shorter time and/or using lower amounts of cleaning liquid. That is, the cleaning can be made more efficient. Thus, the design principle of the link enables a hygienic design of an industrial robot to be improved.

In order for the first cover surface to be substantially flush with the first surface section, any offset therebetween in a direction normal to the first cover surface may be less than 1 mm, such as less than 0.5 mm, such as less than 0.2 mm, such as less than 0.1 mm. The first surface section and the first cover surface may be parallel. Since the first cover sealingly closes the first opening, the first cover may prevent, for example, water from entering into the first opening from an exterior region outside of the link.

Correspondingly, in order for the second cover surface to be substantially flush with the second surface section, any offset therebetween in a direction normal to the second cover surface may be less than 1 mm, such as less than 0.5 mm, such as less than 0.2 mm, such as less than 0.1 mm. The second surface section and the second cover surface may be parallel. Since the second cover sealingly closes the second opening, the second cover may prevent, for example, water from entering into the second opening from an exterior region outside of the link.

Each of the first and second covers may be a lid. Alternatively, or in addition, each of the first and second covers may be round, such as circular or elliptic.

The main body may be hollow. According to some variants, the main body is monolithic. The main body and the first and second covers may close an interior volume extending between the first and second joints when the link is provided in the industrial robot. Since the main surface is exterior, the main surface may face away from such interior volume, e.g., towards an exterior region outside of the link. The main body and the first and second covers may be made of metal, such as steel.

As used herein, a first joint and a second joint of the industrial robot refer to two different and adjacent joints of the industrial robot. For example, first and second joints of the industrial robot may be provided at a fourth axis and a fifth axis, respectively, of the industrial robot.

The first opening and the second opening may be configured to be arranged at the first joint and the second joint, respectively. Thus, when the link is provided in the industrial robot, the first and second openings may be arranged at the first and second joints, respectively. With reference to a largest linear dimension of the link, a first distance between the first opening and the first joint, and a second distance between the second opening and the second joint, may be less than 50%, such as less than 30% of the largest linear dimension.

The first cover surface and the second cover surface may be angled less than 15 degrees, such as less than ten degrees, relative to each other. In some variants, the first and second cover surfaces are parallel. In some variants, the first and second cover surfaces are coplanar, i.e., lie in a common plane.

The entire first surface section and the entire second surface section may be visible from a single perspective. In some variants, the entire main surface is visible from a single perspective.

The main surface may be planar. In these cases, the first and second cover surfaces are coplanar.

The first surface section may at least partly enclose the first opening and/or the second surface section may at least partly enclose the second opening. The first and second surface sections may for example angularly enclose at least 80 degrees, such as at least 170 degrees, such as at least 260 degrees, of the first and second openings, respectively.

The first surface section may entirely enclose the first opening and/or the second surface section may entirely enclose the second opening.

The link may further comprise a first external seal bridging a first gap between the first surface section and the first cover surface, and a second external seal bridging a second gap between the second surface section and the second cover surface. The first external seal may thus interconnect the first surface section and the first cover surface, and the second external seal may thus interconnect the second surface section and the second cover surface. The first external seal may form within the first gap a closed path entirely visible from a single first perspective. Correspondingly, the second external seal may form within the second gap a closed path entirely visible from a single second perspective. According to one variant, the first and second external seals may form with the first and second gaps, respectively, first and second closed paths both entirely visible from a single perspective.

Each of the first external seal and the second external seal may be substantially flush with, or flush with, the main surface or bulge out externally with respect to the main surface.

The main surface may include an intermediate section interconnecting the first surface section and the second surface section.

The intermediate section may be planar. Alternatively, the intermediate section may comprise one or more curved portions none having a radius of curvature of less than 3 mm. Each curved portion may comprise a circular arc of a circle centered at a curvature axis. Each curvature axis may be parallel with one or both of the first and second surface sections.

According to a second aspect, there is provided an industrial robot comprising a first joint, a second joint, and a link according to the first aspect interconnecting the first joint and the second joint. The industrial robot may comprise a plurality of links interconnected by a plurality of joints. The industrial robot may be programmable in three or more axes, such as in six or seven axes. The links and the joints may form a serial manipulator.

The first cover may be positioned closer to the first joint than to the second joint. In these cases, the second cover may be positioned closer to the second joint than to the first joint. In some variants, the first cover is positioned closer to the first joint than to the second cover, and the second cover is positioned closer to the second joint than to the first cover.

### BRIEF DESCRIPTION OF THE DRAWINGS

Further details, advantages and aspects of the present disclosure will become apparent from the following description taken in conjunction with the drawings, wherein:

FIG. 1 schematically represents a first perspective side view of an industrial robot;

FIG. 2 schematically represents a second perspective side view of the industrial robot;

FIG. 3 schematically represents a top view of a link of the industrial robot;

FIG. 4 schematically represents a top view of the link in FIG. 3 when two covers have been added;

FIG. 5 schematically represents a partial side view of the link in FIGS. 3 and 4;

FIG. 6 schematically represents a partial side view of a link for the industrial robot according to a further example;

FIG. 7 schematically represents a partial side view of a link for the industrial robot according to a further example;

FIG. 8 schematically represents a top view of a link for the industrial robot according to a further example; and

FIG. 9 schematically represents a partial side view of the link in FIG. 8.

### DETAILED DESCRIPTION

In the following, a link for an industrial robot, and an industrial robot comprising a link, will be described. The same or similar reference numerals will be used to denote the same or similar structural features.

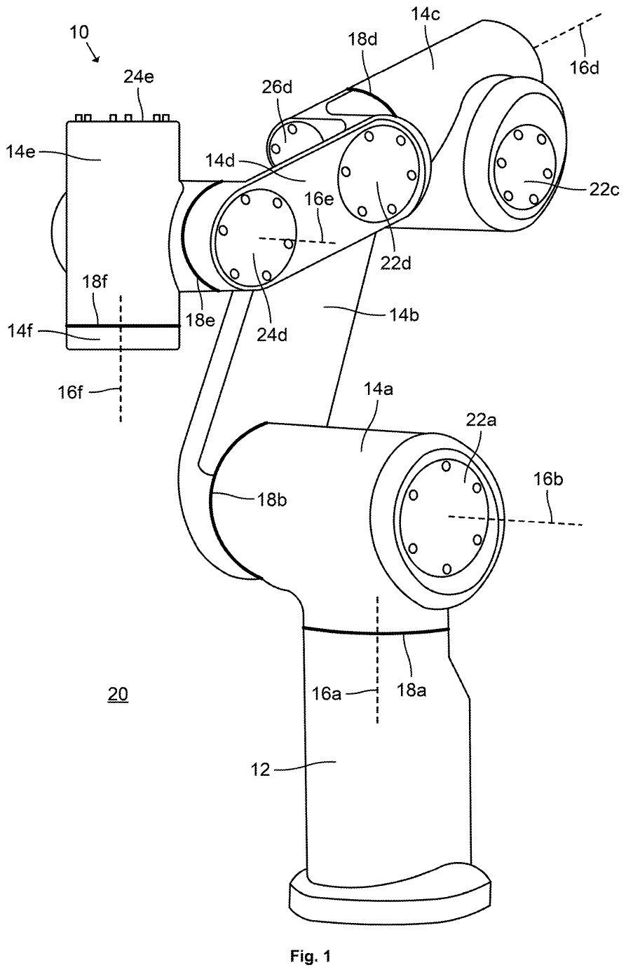

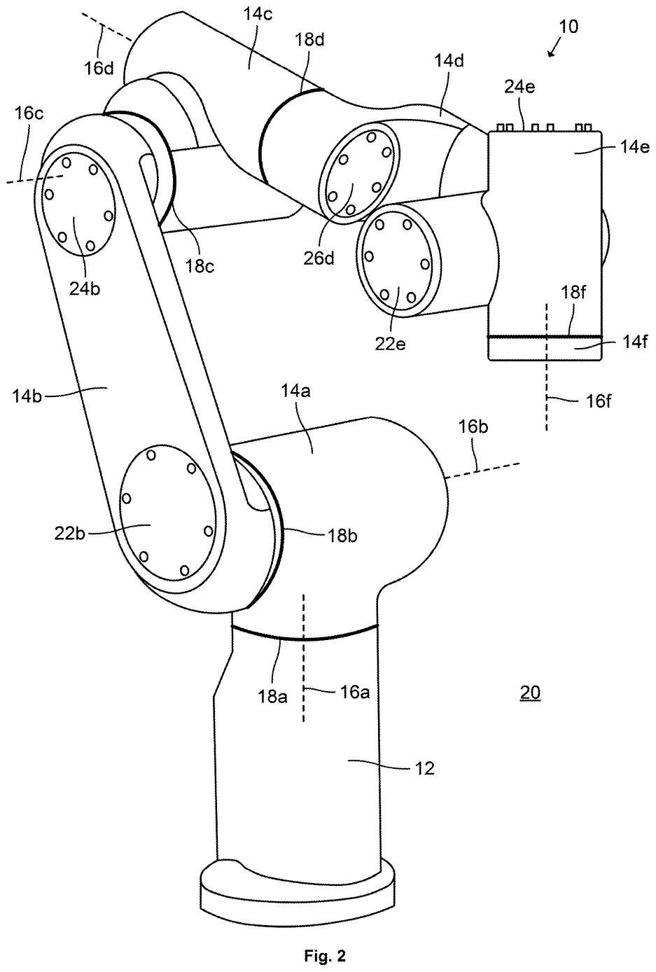

FIG. 1 schematically represents a first perspective side view of an industrial robot 13, and FIG. 2 schematically represents a second perspective side view of the industrial robot 10. With collective reference to FIGS. 1 and 2, the industrial robot 10 of this specific and non-limiting example comprises a base 12, a first link 14a rotatable relative to the base 12 around a first joint axis 16a at a first joint 18a, a second link 14b rotatable relative to the first link 14a around a second joint axis 16b at a second joint 18b, a third link 14c rotatable relative to the second link 14b around a third joint axis 16c at a third joint 18c, a fourth link 14d rotatable relative to the third link 14c around a fourth joint axis 16d at a fourth joint 18d, a fifth link 14e rotatable relative to the fourth link 14d around a fifth joint axis 16e at a fifth joint 18e, and a sixth link 14f rotatable relative to the fifth link 14e around a sixth joint axis 16f at a sixth joint 18f. The industrial robot 10 of this example is thus a serial manipulator programmable in six axes. An end effector, such as a gripper, may be fixed to the sixth link 14f.

One, several or all of the links 14a-14f, one, several or all of the joint axes 16a-16f, and one, several or all of the joints 18a-18f may also be referred to with reference numerals “14”, “16” and “18”, respectively. For each joint 18, the industrial robot 10 comprises an electric motor and a gearbox (not shown) for driving the link 14 around the joint axis 16.

At the first joint 18a, a seal bridges a gap between a main body of each of the base 12 and the first link 14a. At each joint 18b-18f, a seal bridges a gap between main bodies of two different links 14.

FIGS. 1 and 2 also denote an exterior region 20 outside of the industrial robot 10. The industrial robot 10 is a hygienic robot that prevents ingress of fluids and particles. The industrial robot 10 may for example operate in a hygienic environment to handle food, beverages or pharmaceuticals. In order to prevent contamination of the environment by the industrial robot 10, the industrial robot 10 may regularly be subjected to a washdown process. To this end, hot pressurized water, cleaning agents and disinfectants may be sprayed on the industrial robot 10.

In the industrial robot 10 of this specific example, the first link 14a comprises a first lid 22a, the second link 14b comprises a first lid 22b and a second lid 24b, the third link 14c comprises a first lid 22c, the fourth link 14d comprises a first lid 22d, a second lid 24d and a third lid 26d, and the fifth link 14e comprises a first lid 22e and a second lid 24e. One, several or all of the first lids 22a-22e, and one, several or all of the second lids 24b, 24d and 24e, may also be referred to with reference numerals “22” and “24”, respectively. Each lid 22, 24 and 26d sealingly closes an opening in the respective link 14. By removing any of the lids 22, 24 and 26d, an interior of the industrial robot 10 can be accessed. The lids 22, 24 and 26d are examples of covers according to the present disclosure.

In this example, the first link 14a can be mounted to the base 12 through an opening covered by the first lid 22a. More specifically, the first link 14a can be mounted to a gearbox of the first joint 18a by inserting a tool through the opening covered by the first lid 22a.

In this example, the second link 14b can be mounted to the first link 14a through an opening covered by the first lid 22b. More specifically, the second link 14b can be mounted to a gearbox of the second joint 18b by inserting a tool through the opening covered by the first lid 22b. As shown in FIG. 2, each of a first distance between the first lid 22b and the second joint 18b, and a second distance between the second lid 24b and the third joint 18c, is less than 30% of a largest linear dimension of the second link 14b. The first lid 22b is positioned closer to the second joint 18b than to the second lid 24b. Conversely, the second lid 24b is positioned closer to the third joint 18c than to the first lid 22b.

In this example, the third link 14c can be mounted to the second link 14b through an opening covered by the second lid 24b. More specifically, the third link 14c can be mounted to a gearbox of the third joint 18c by inserting a tool through the opening covered by the second lid 24b.

In this example, the fourth link 14d can be mounted to the third link 14c through an opening covered by the third lid 26d. More specifically, the fourth link 14d can be mounted to a gearbox of the fourth joint 18d by inserting a tool through the opening covered by the third lid 26d. An opening closed by the first lid 22d may be used to remove a mold core after molding of the fourth link 14d. The first lid 22d is positioned closer to the fourth joint 18d than to the fifth joint 18e. Conversely, the second lid 24d is positioned closer to the fifth joint 18e than to the fourth joint 18d. Moreover, the second lid 24d is positioned closer to the fifth joint 18e than to the first lid 22d.

In this example, the fifth link 14e can be mounted to the fourth link 14d through an opening covered by the second lid 24d or through an opening covered by the first lid 22e. More specifically, the fifth link 14e can be mounted to a gearbox of the fifth joint 18e by inserting a tool through the opening covered by the second lid 24d or through the opening covered by the first lid 22e.

In this example, the sixth link 14f can be mounted to the fifth link 14e through an opening covered by the second lid 24e. More specifically, the sixth link 14f can be mounted to a gearbox of the sixth joint 18f by inserting a tool through the opening covered by the second lid 24e.

Through openings covered by the first lids 22, the second lids 24 and the third lid 26d, a cable harness may be manually accessed to be routed inside of the industrial robot 10 between the base 12 and the sixth link 14f, i.e., through all the joints 18.

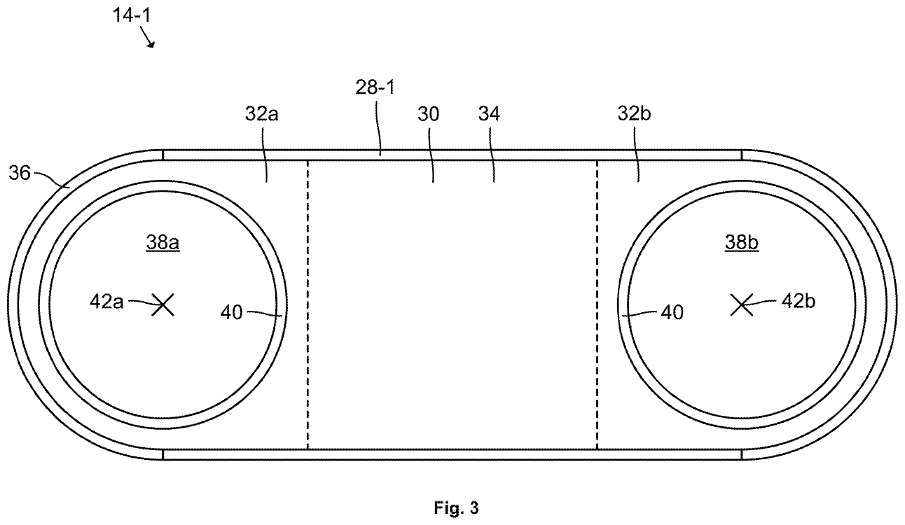

FIG. 3 schematically represents a top view of a link 14-1. The link 14-1 may constitute one or several of the links 14 of the industrial robot 10, such as the second link 14b and/or the fourth link 14d. The link 14-1 comprises a main body 28-1. The main body 28-1 of this example is hollow, monolithic and made of metal, such as steel.

In case the link 14-1 constitutes the second link 14b, the main body 28-1 interconnects the second joint 18b and the third joint 18c. In case the link 14-1 constitutes the fourth link 14d, the main body 28-1 interconnects the fourth joint 18d and the fifth joint 18e.

The main body 28-1 comprises an exterior continuous main surface 30. Thus, when the link 14-1 is used as any of the links 14 of the industrial robot 10, the main surface 30 faces towards the exterior region 20. The main surface 30 of this example is planar. As shown in FIG. 3, the main surface 30 of this example includes a planar first surface section 32a, a planar second surface section 32b and a planar intermediate section 34 interconnecting the first surface section 32a and the second surface section 32b. Transitions between the first surface section 32a and the intermediate section 34, and between the intermediate section 34 and the second surface section 32b are however not visible in this example.

The main body 28-1 further comprises a curved edge 36 enclosing the main surface 30. The curved edge 36 has a radius of at least 3 mm. Moreover, the curved edge 36 is here tangential with the main surface 30.

The main body 28-1 further comprises a first opening 38a in the first surface section 32a and a second opening 38b in the second surface section 32b. The first and second openings 38a and 38b of this example are circular and comprise a step 40. The first opening 38a defines a central first depth axis 42a transverse to the first surface section 32a. The second opening 38b defines a central second depth axis 42b transverse to the second surface section 32b. In this example, the first surface section 32a entirely encloses the first opening 38a, and the second surface section 32b entirely encloses the second opening 38b.

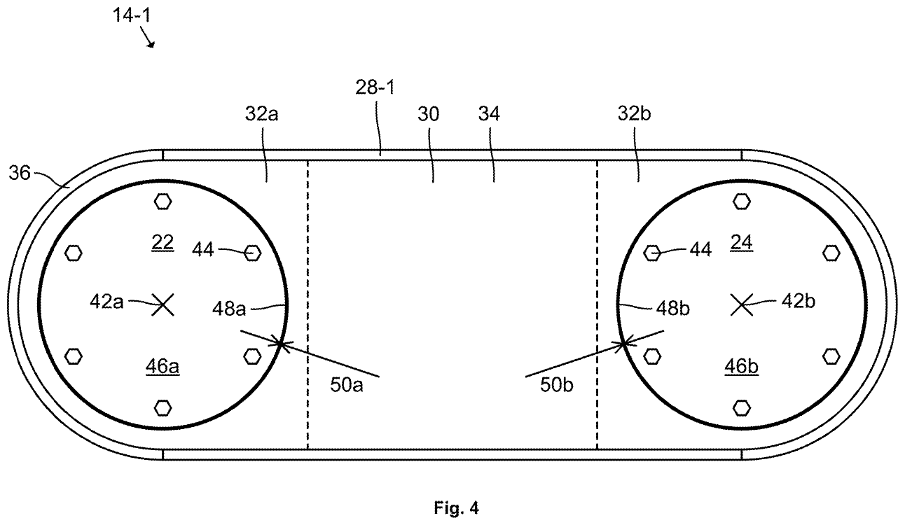

FIG. 4 schematically represents a top view of the link 14-1. In FIG. 4, the first lid 22 and the second lid 24 have been added. The first and second lids 22 and 24 of this example are seated on the steps 40 and secured to the main body 28-1 by fasteners, here exemplified as bolts 44. The first and second lids 22 and 24 of this example are circular.

The first lid 22 comprises an exterior planar first cover surface 46a. The second lid 24 comprises an exterior planar second cover surface 46b.

The first lid 22 sealingly closes the first opening 38a and the second lid 24 sealingly closes the second opening 38b. To this end, the link 14-1 of this example comprises a first external seal 48a and a second external seal 48b. The first external seal 48a bridges a first gap 50a between the first surface section 32a and the first cover surface 46a. The second external seal 48b bridges a second gap 50b between the second surface section 32b and the second cover surface 46b. Each of the first and second external seals 48a and 48b forms a closed path, both of which are entirely visible from a single perspective, such as in the view according to FIG. 4.

In this example, the entire first surface section 32a and the entire second surface section 32b are visible from a single perspective, such as in the view according to FIG. 4. Moreover, in this example, also the entire main surface 30 is visible from a single perspective.

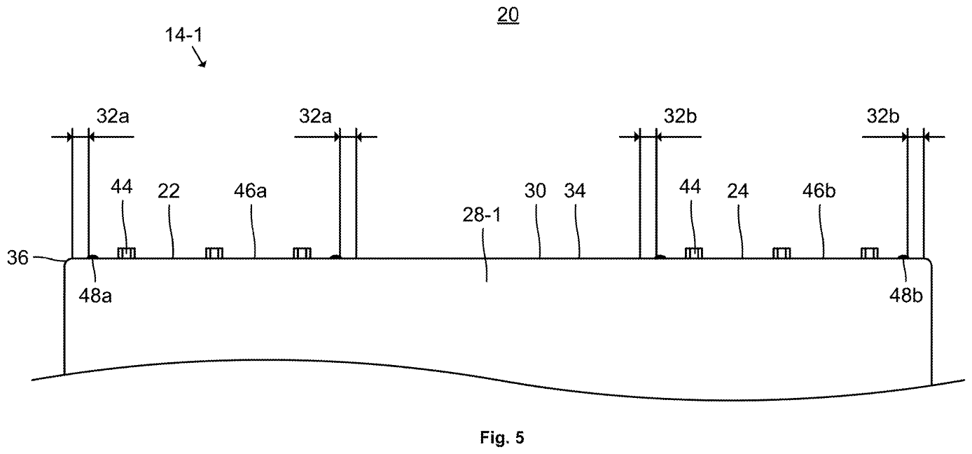

FIG. 5 schematically represents a partial side view of the link 14-1. In FIG. 5, the first and second external seals 48a and 48b are shown in partial cross-section. As shown in FIG. 5, the first cover surface 46a is flush with the first surface section 32a and the second cover surface 46b is flush with the second surface section 32b. In this example, the main surface 30 and the first and second cover surfaces 46a and 46b thus lie in a common plane.

The first and second external seals 48a and 48b bulge out slightly externally relative to the main surface 30. In this example, the first and second external seals 48a and 48b and the bolts 44 constitute the only interruptions in an otherwise continuous plane. Thereby, accumulation of contaminants is reduced, and the main surface 30 and the first and second cover surfaces 46a and 46b can be cleaned with maximum effectiveness and minimum effort. More specifically, due to the design of the link 14-1, there is a reduced risk of contaminants adhering thereto, a detergent can more easily reach all areas of the link 14-1, and the detergent can be more easily washed off from the link 14-1. The hygienic safety of the industrial robot 10 is thereby improved. Moreover, the entire main surface 30 and the entire first and second cover surfaces 46a and 46b can be efficiently cleaned by spraying a cleaning medium from a nozzle moving translationally with a fixed orientation in space.

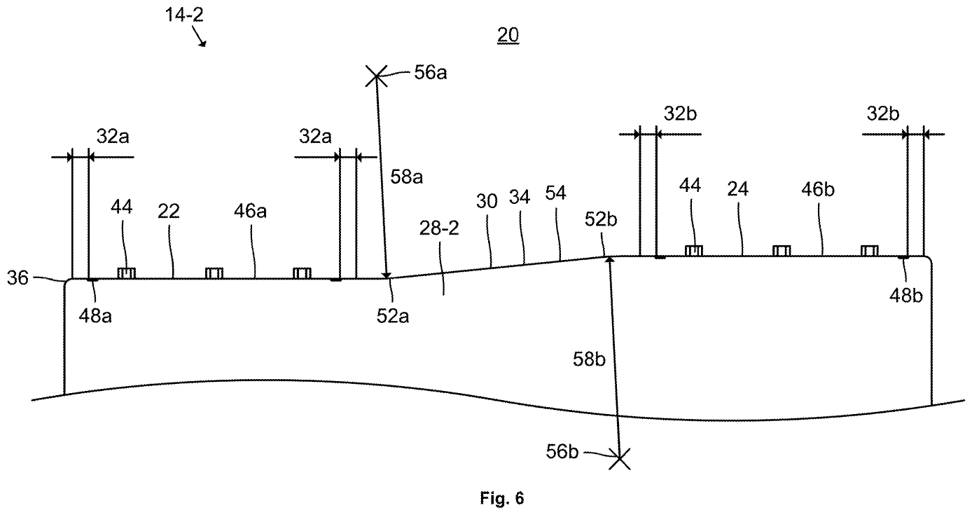

FIG. 6 schematically represents a partial side view of a link 14-2. Mainly differences with respect to the link 14-1 will be described. The link 14-2 comprises a main body 28-2. The intermediate section 34 of the main body 28-2 comprises a first curved portion 52a, a second curved portion 52b, and a planar intermediate portion 54 interconnecting the first and second curved portions 52a and 52b. The first curved portion 52a comprises a circular arc of a circle (not shown) centered at a first curvature axis 56a parallel with the first surface section 32a and having a first radius of curvature 58a. The second curved portion 52b comprises a circular arc of a circle (not shown) centered at a second curvature axis 56b parallel with the second surface section 32b and having a second radius of curvature 58b. Each of the first and second radii of curvature 58a and 58b is at least 3 mm. In this example, the first and second curvature axes 56a and 56b are parallel.

As shown in FIG. 6, the first and second cover surfaces 46a and 46b are parallel but offset.

Moreover, in this example, the first and second external seals 48a and 48b are flush with the first and second surface sections 32a and 32b, respectively.

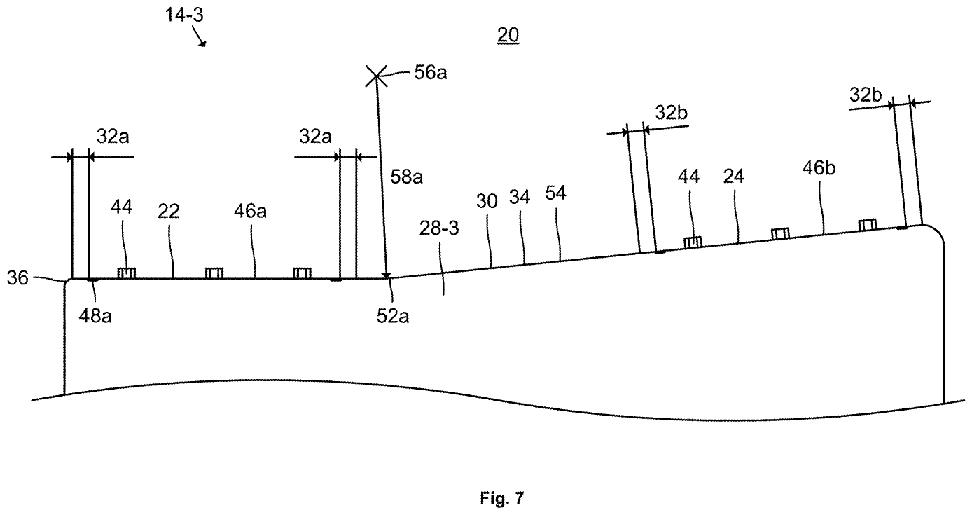

FIG. 7 schematically represents a partial side view of a link 14-3. Mainly differences with respect to the link 14-2 will be described. The link 14-3 comprises a main body 28-3. The intermediate section 34 of the main body 28-3 comprises the first curved portion 52a and the intermediate portion 54, but not the second curved portion 52b. The second cover surface 46b is thereby flush with both the second surface section 32b and the intermediate portion 54. Moreover, the second cover surface 46b is angled relative to the first cover surface 46a, here approximately five degrees.

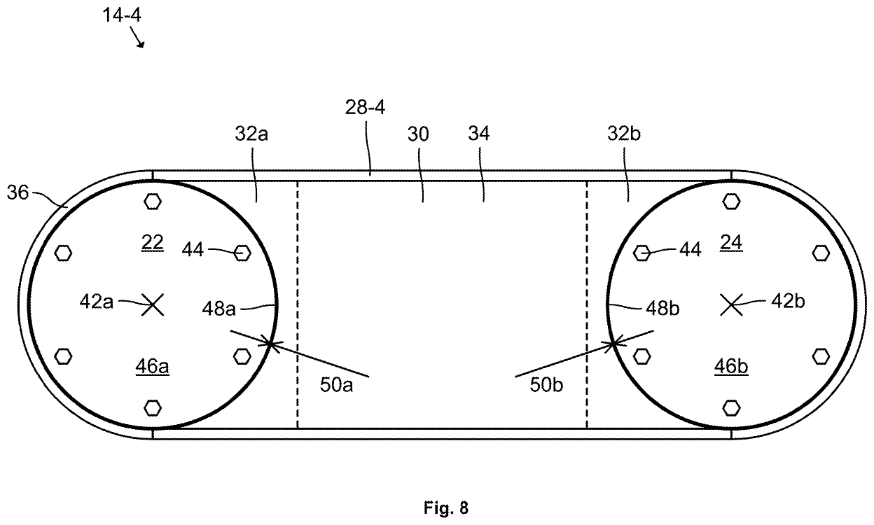

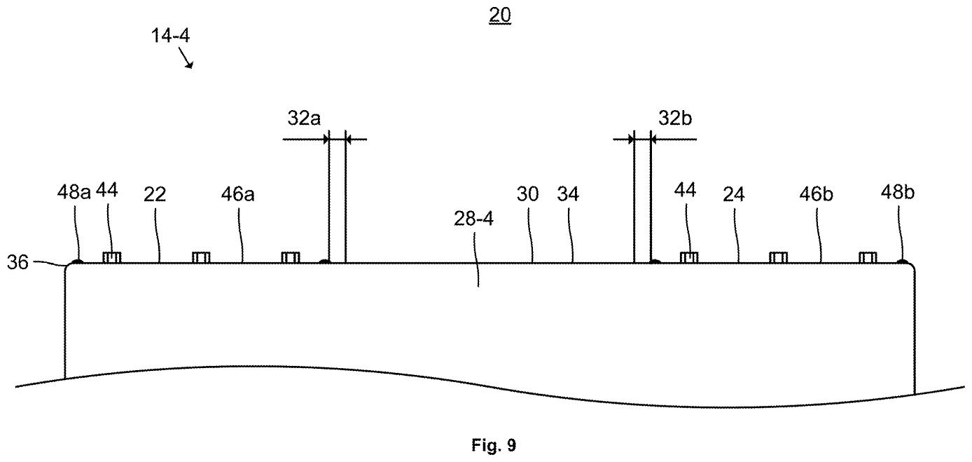

FIG. 8 schematically represents a top view of a link 14-4, and FIG. 9 schematically represents a partial side view of the link 14-4. With collective reference to FIGS. 8 and 9, mainly differences with respect to the link 14-1 will be described. The link 14-4 comprises a main body 28-4. In the main body 28-4, the first surface section 32a only partially encloses the first lid 22, here 180 degrees around the first depth axis 42a, and the second surface section 32b only partially encloses the second lid 24, here 180 degrees around the second depth axis 42b. Moreover, the curved edge 36 is tangential with each of the first and second cover surfaces 46a and 46b.

One, several or all of the links 14-1 to 14-4, and one, several or all of the main bodies 28-1 to 28-4 may also be referred to with reference numerals “14” and “28”, respectively.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A link for an industrial robot, the link comprising:
a main body for interconnecting a first joint and a second joint of the industrial robot, the main body comprising an exterior continuous main surface including a planar first surface section and a planar second surface section;
a first opening in the first surface section;
a second opening in the second surface section;
a first cover sealingly closing the first opening and including an exterior planar first cover surface substantially flush with the first surface section; and
a second cover sealingly closing the second opening and including an exterior planar second cover surface substantially flush with the second surface section.

2. The link according to claim 1, wherein the first opening and the second opening are configured to be arranged at the first joint and the second joint, respectively.

3. The link according to claim 1, wherein the first cover surface and the second cover surface are angled less than 15 degrees relative to each other.

4. The link according to claim 1, wherein the entire first surface section and the entire second surface section are visible from a single perspective.

5. The link according to claim 1, wherein the main surface is planar.

6. The link according to claim 1, wherein the first surface section at least partly encloses the first opening and/or the second surface section at least partly encloses the second opening.

7. The link according to claim 1, wherein the first surface section entirely encloses the first opening and/or the second surface section entirely encloses the second opening.

8. The link according to claim 1, further comprising a first external seal bridging a first gap between the first surface section and the first cover surface, and a second external seal bridging a second gap between the second surface section and the second cover surface.

9. The link according to claim 8, wherein each of the first external seal and the second external seal is substantially flush with the main surface or bulges out externally with respect to the main surface.

10. The link according to claim 1, wherein the main surface includes an intermediate section interconnecting the first surface section and the second surface section.

11. The link according to claim 10, wherein the intermediate section is planar, or wherein the intermediate section includes one or more curved portions none having a radius of curvature of less than 3 mm.

12. An industrial robot comprising a first joint, a second joint, and a link including:
a main body for interconnecting a first joint and a second joint of the industrial robot, the main body comprising an exterior continuous main surface including a planar first surface section and a planar second surface section;
a first opening in the first surface section;
a second opening in the second surface section;
a first cover sealingly closing the first opening and including an exterior planar first cover surface substantially flush with the first surface section; and
a second cover sealingly closing the second opening and including an exterior planar second cover surface substantially flush with the second surface section;
the link interconnecting the first joint and the second joint.

13. The industrial robot according to claim 12, wherein the first cover is positioned closer to the first joint than to the second joint, and wherein the second cover is positioned closer to the second joint than to the first joint.

14. The link according to claim 2, wherein the first cover surface and the second cover surface are angled less than 15 degrees relative to each other.

15. The link according to claim 2, wherein the entire first surface section and the entire second surface section are visible from a single perspective.

16. The link according to claim 2, wherein the main surface is planar.

17. The link according to claim 2, wherein the first surface section at least partly encloses the first opening and/or the second surface section at least partly encloses the second opening.

18. The link according to claim 2, wherein the first surface section entirely encloses the first opening and/or the second surface section entirely encloses the second opening.

19. The link according to claim 2, further comprising a first external seal bridging a first gap between the first surface section and the first cover surface, and a second external seal bridging a second gap between the second surface section and the second cover surface.
